(19) United States
(12) Patent Application Publication
(10) Pub. No.: US 2018/0346224 A1
(43) Pub. Date: Dec. 6, 2018

(54) Break Disk Insert

(71) Applicant: Josue Pantoja, Hamilton, NJ (US)

(72) Inventor: Josue Pantoja, Hamilton, NJ (US)

(21) Appl. No.: 15/473,925

(22) Filed: Jun. 5, 2017

(51) Int. Cl. B65D 81/133; F16D 65/12; D21F 11/12

(52) U.S. Cl. CPC B65D 81/133; B65D 2585/6882; D21F 11/12; F16D 65/12

(57) ABSTRACT

My brake disk cardboard insert design is made of ( 3/16 inch) cardboard with two large square sections that fold over the break disk and three additional smaller folding lip-panels located on the bottom larger square. One in the front, one in the right side and one in the left side. These three smaller folding panels have corrugated lines used to secure the folded larger squares in place with tape or staples depending the size of break disk being shipped. There is a circle in the center of both lager squares with two inner corrugated tear out rings for different break disk hub sizes. There is also a rectangular section in between both larger squares with an oval organ fold which is to be recessed into the break disk base once it's folded in place when completed. This design allows the break disk to fit perfectly flush into its designated shipping box and in turn will prevent any damage to the shipping box or break disk during transit preventing repackaging and additional fees in any shipping terminals.

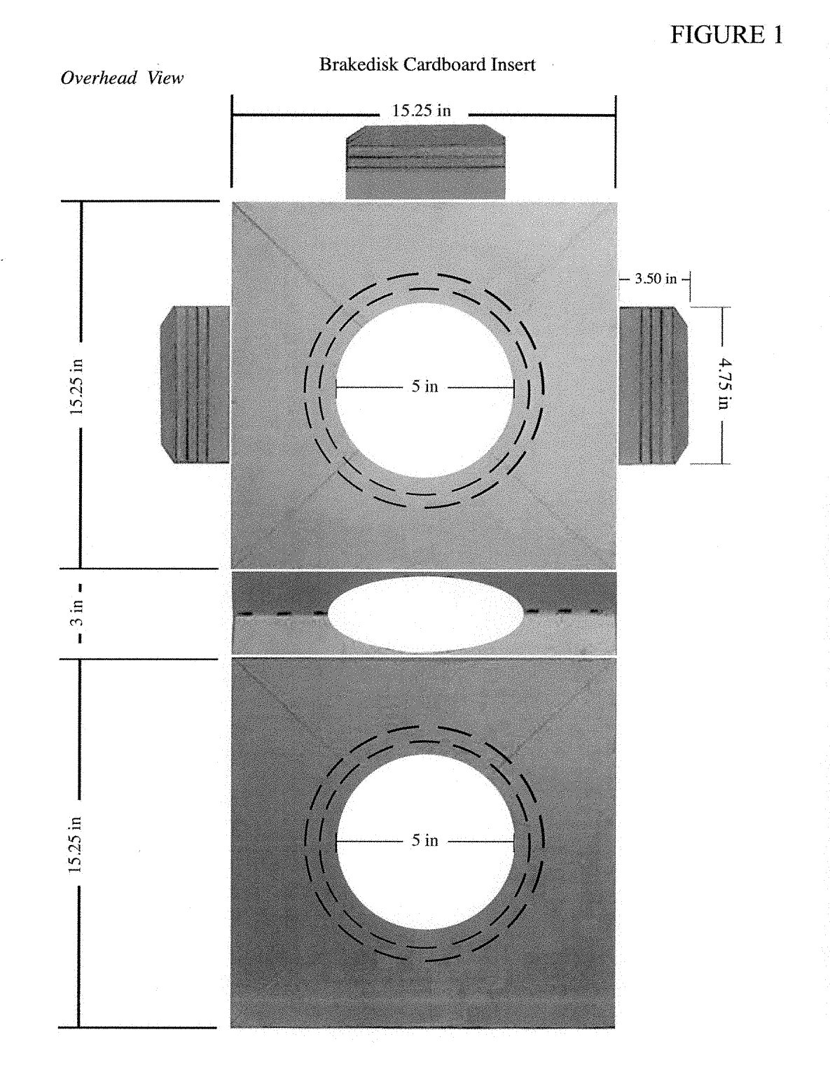

FIG. 1 is a completely open overhead view of dimension and sizes of the outer lips and the inner corrugated tear out ring.

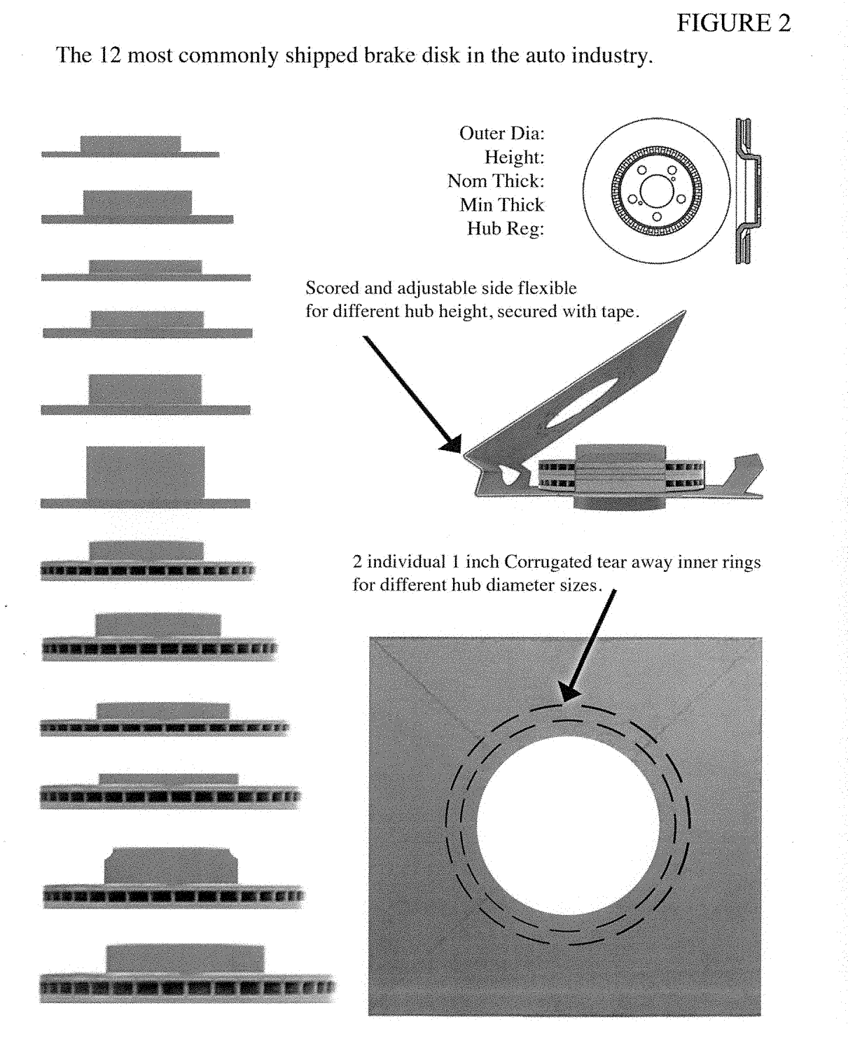

FIG. 2 is an example on how to use the corrugated tear out rings in the cardboard insert. Also shows the different brake disk diameter that can be use with this insert (None of the brake disks in FIG. 2 are part of the design.)

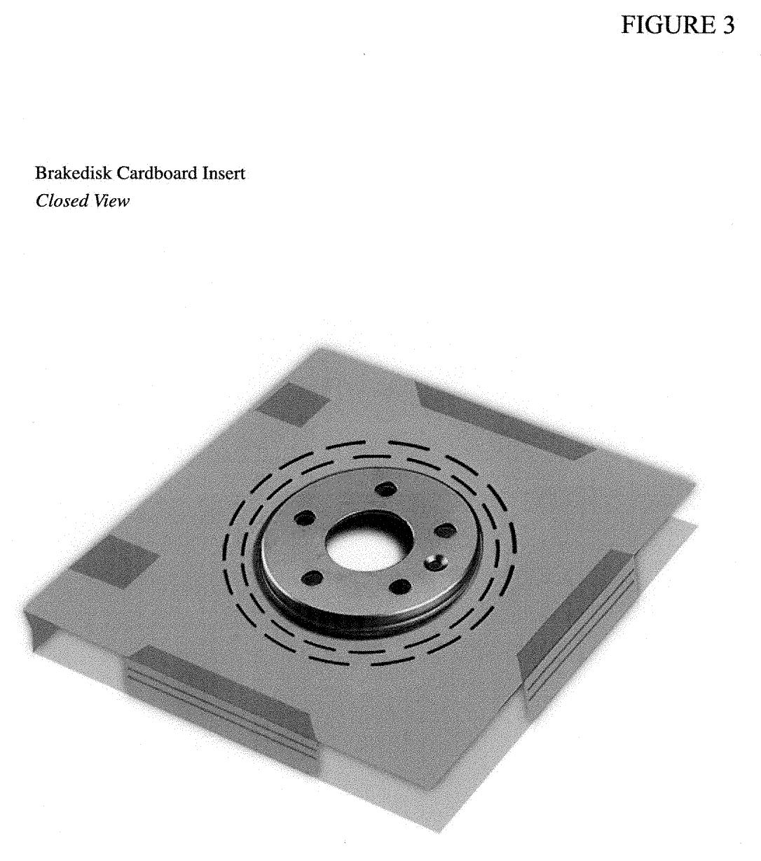

FIG. 3 is a description of how the brake disk insert will look once is closed and completed (The brake disk in FIG. 3 is not part of the design.)

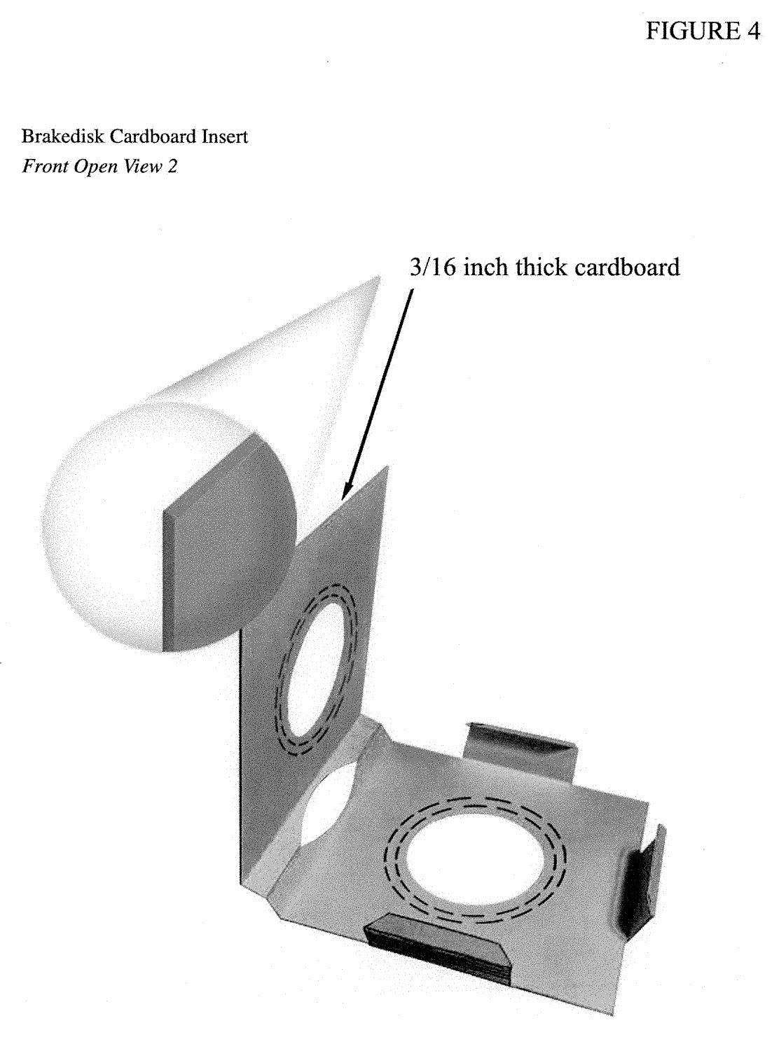

FIG. 4 shows an overhead open view describing the thickness of cardboard that will be use for this brake disk insert.

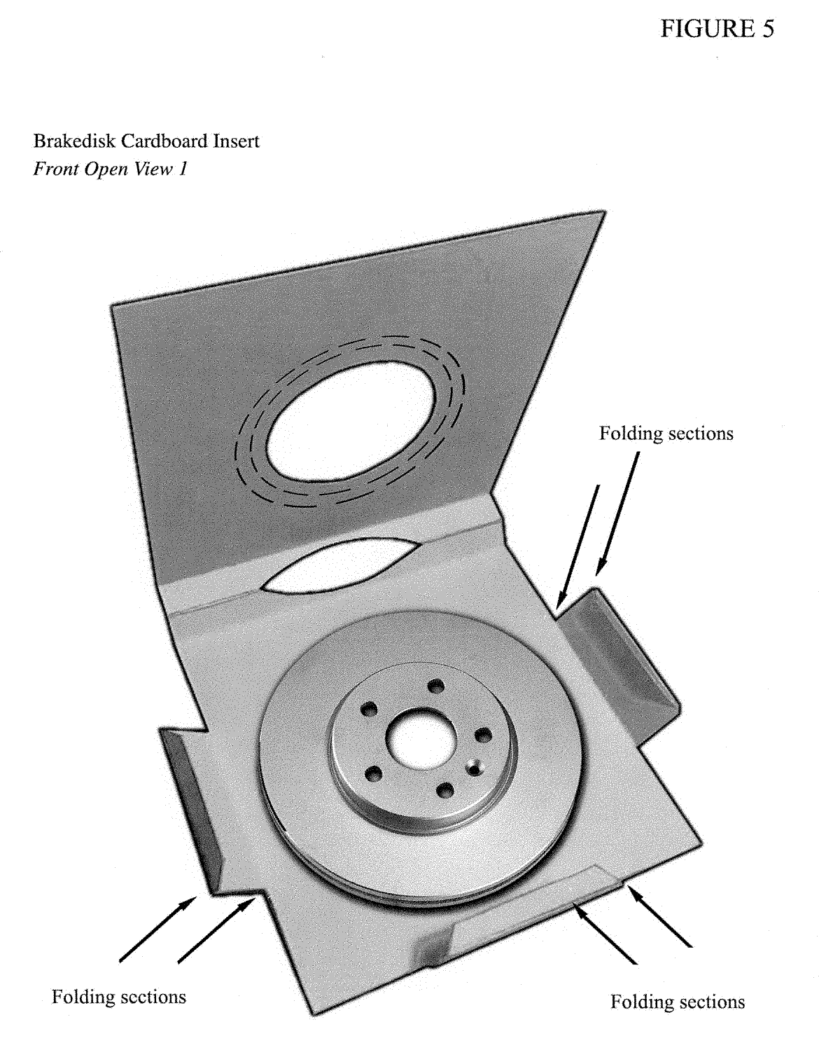

FIG. 5 is an overhead open view of the brake disk insert (The brake disk in FIG. 5 is not part of the design.)

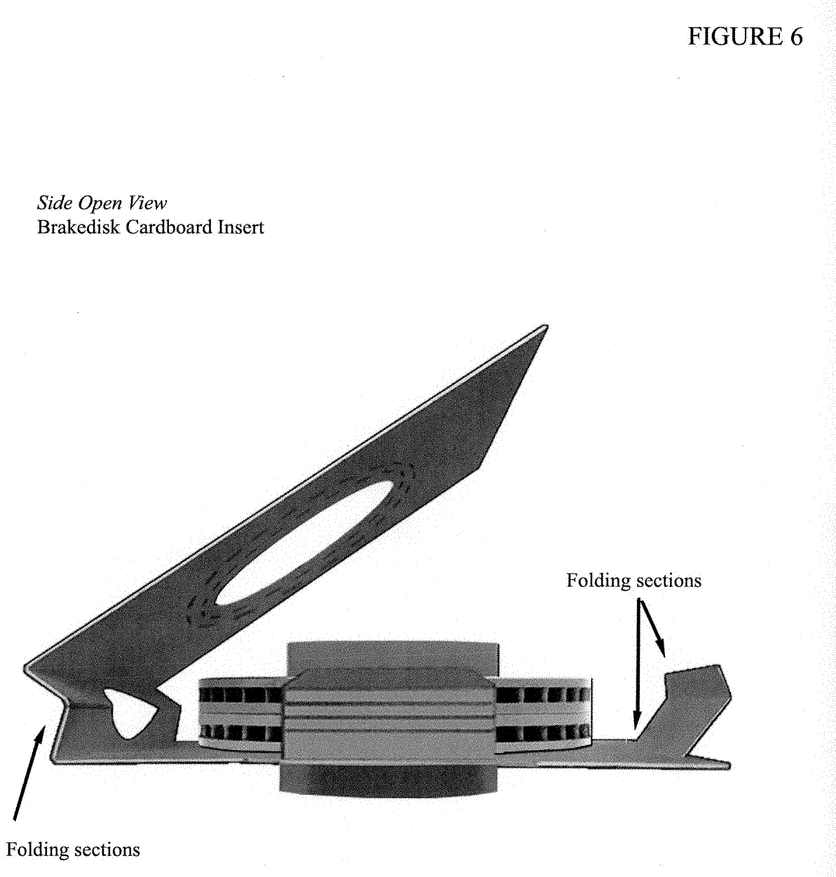

FIG. 6 is a side open view of the brake disk insert. It also shows how the side lips are to be used. There is also a folding section that recesses around the brake disk (The brake disk in FIG. 6 is not part of the design.)

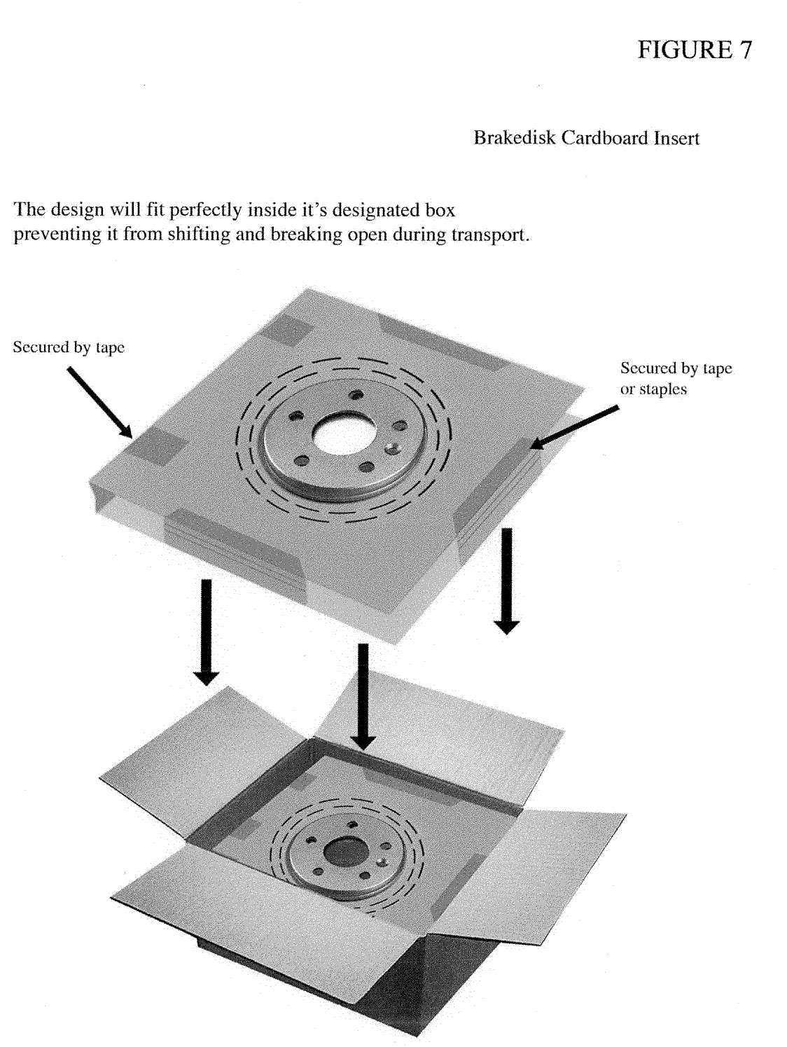

FIG. 7 is a description of how the brake disk insert is fully assembled and how it will go inside a box (The open box is not part of the design in FIG. 7.)

My break disk cardboard insert is made from approximately 3/16 inch thick cardboard shown on FIG. 4. It has 7 folding sections shown on FIGS. 5 and 6 with two corrugated tear out inner circle for different size break disk also shown on FIG. 5.

There are two 15½×15 ½ squares, in between both it has an accordion inner fold of 3 inches shown on FIG. 2. It has three flaps on three different sides of the large squares measuring 4¾ with corrugated lines for break disk thickness fold shown on FIGS. 1 and 5. FIG. 3 shows how it would look when it's completed and FIG. 7 describes how it would be placed in the box for shipment.

1. I claim that my break disk cardboard insert will prevent the boxes that there shipped in to arrive at there destination torn and with an undamaged product.
The parts distribution industry has encountered packaging issues with shipping brake disk. The process is time consuming and not very efficient. Packing these boxes for shipping takes approximately 3 to 5 minutes for each pair. Shipping terminals are beginning to charge a fee to repack these boxes due to previous poor packaging. Brake disk are currently shipped in pairs, using honey comb and other expensive packaging materials to prevent it from breaking open. Before reaching it's destination these boxes travel through long conveyor systems and get loaded and unloaded many times increasing the chances of uneven weight distribution causing the boxes to rip. The purpose of this design is to prevent the brake disk from shifting during transit and breaking open due to mishandling. It takes seconds to assemble saving time and money.
